(19) United States
(12) Patent Application Publication
(10) Pub. No.: US 2006/0126814 A1
(43) Pub. Date: Jun. 15, 2006

(54) AIN enabled automated directory assistance in a telecommunications network

(76) Inventors: Wilfred Weidmark, Toronto (CA); Renee Berkowitz, Englishtown, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/766,408

(22) Filed: Jan. 27, 2004

(51) Int. Cl. H04M 3/42

(52) U.S. Cl. 379/218.01

(57) ABSTRACT

In a telecommunications network comprised of wireline and wireless subscribers, automated directory assistance is provided through a plurality of directory assistance voice peripherals. Such directory assistance voice peripherals are able to query the subscriber requesting assistance in response to a dialed 411 or other directory assistance request. A subscriber request is sent from the local or tandem switch (SSP or WIN MSC) to an intelligent service control point (SCP) which directs control of the request, queries the line information database, routes the request to a directory assistance voice peripheral and the directory assistance voice peripheral notifies the directory assistance controller. The assigned directory assistance voice peripheral interacts with the subscriber to determine the query. The query is satisfied by the directory assistance controller through the directory assistance database. Once the query is answered the call is released by the SCP and routed to the end-office servicing the newly called number. If the directory assistance controller is unable to find the results requested, then the call is routed to the OSS using a called number that enables correlation. The OSS sends a message to the SCP, the SCP retrieves the called number from the message and correlates the received message with the active call context. The SCP requests the OSS to place the caller on hold, obtains a different correlation ID and routing number from the directory assistance voice peripheral, requests the OSS to connect the directory assistance voice peripheral to the call, requests the OSS to attach an operator, provides context information (e.g., city, state, and listing) to the operator, and requests the DA_VP to play the end user's utterance to the operator. The directory assistance voice peripheral complies and releases. The SCP then either releases or waits for the results from the operator. In the scenario in which the SCP waits for results from the operator, the operator obtains the results of the request and releases the call. The OSS provides the SCP with the results. The SCP then requests the AIN SSP to route the call to the end office serving the called number and generates the OS AMA records. For some call types, the directory assistance service may be invoked from the OSS. In this case, the OSS sends a request for instructions to the SCP and the SCP connects the subscriber to the directory assistance voice peripheral via the PSTN and without using dedicated voice links between the OSS and directory assistance voice peripheral. The directory assistance voice peripheral notifies the directory assistance controller. The assigned directory assistance voice peripheral interacts with the subscriber to determine the query. The query is satisfied by the directory assistance controller through the directory assistance database. Once the query is answered, the call is released by the SCP and routed by the OSS to the end-office servicing the newly called number.

### FIELD OF THE INVENTION

This invention is related to a system and method for handling operator dependent services such as directory assistance in a telecommunications network. More specifically, the invention relates to a system and method for completing requests for directory assistance through the use advanced intelligent network (AIN) elements at the originating end-office.

### BACKGROUND

Automation has become increasingly important in providing operator services. Many techniques are used to reduce the amount of actual time an operator spends on each individual subscriber request. For example, text processing and voice recognition are used to attempt to pre-determine caller requirements prior to connection to a live operator. Advances in speech processing technology have enabled some calls to be processed in their entirety without human intervention. Currently, approximately twenty-percent of all calls fall into this category but the number is expected to rise due to the acceleration in voice processing technology research driven by the emergence of VXML as a means of voice activating the Internet.

Traditionally, calls requiring operator assistance, such as collect calls, calling card calls, third party billing and directory assistance calls, have been routed from the switch originating the call to a more centralized Operator Services Switch (OSS) that integrates the specialized operator position software and automation peripheral equipment. This requires that trunk groups be provisioned from all local offices up to the OSS and that the facilities be sized to handle the Erlangs of traffic, including hold-times, automated call components and operator call components of all such calls. In addition, if the processing results in a call being routed to another destination then the call will occupy two facilities for the entire duration of the subsequent call. Also, each call routed through the OSS equipment uses capacity of that highly specialized system for the duration of the total call time.

Operating companies have a strong economic incentive to minimize their dependence upon centralized Operator Services Switches and the attendant network expenses. Therefore, it is desirable to have a system that allows processing of directory assistance calls at the local end-office or a tandem switch, thereby engaging the OSS only for those calls and portions thereof that require human intervention. Such a system and method would allow network operators to decrease the number of OSS systems needed and to reduce the number of subtending facilities.

Further, it would be desirable to have a system implement directory assistance by invoking the same automated voice scripts either from an end office or tandem switch prior to routing the call to the OSS or from the OSS after the call is routed to the OSS. This flexibility enables carriers to retain some existing connections to OSSs (e.g., connections between the carriers OSSs and wireless mobile switching centers (MSCs), if desired.

Also, it would be desirable to have a system implement directory assistance in front of and behind the OSS without using dedicated voice links from the OSS switch to result in significant cost avoidance for the carrriers.

Additionally, it would be desirable to have a system and method that achieves the above in both wireless and wireline environments.

### SUMMARY

In accordance with the present invention, a method and system for automated handling of directory assistance requests includes service for both wireline and wireless offices, fall through to operator position with full context information, call completion from the end office with answer determination and branding and handling of restrictions using information from the line information database (LIDB). A plurality of directory assistance voice peripherals can be located throughout a network in communication with the various wireline or wireless switches that provide service to a plurality of subscribers. The directory assistance voice peripherals are controlled by a central controller to provide automated directory assistance to subscribers. In the present invention automated directory assistance is provided to one or more subscribers connected to a telecommunications network through a local or tandem switch with service switching point (SSP) capabilities each interacting with one or more directory assistance voice peripherals. After receiving a request for directory assistance from a first subscriber at a local switch, the request is routed to a service control point (SCP) in communication with said local or tandem switch. The request is temporarily connected to an assigned directory assistance voice peripheral. A message is sent from the SCP to a directory assistance controller regarding directory assistance voice peripheral assigned to the request. The assigned directory assistance voice peripheral solicits information regarding said request from the requesting subscriber to form a directory assistance query. The directory assistance query is forwarded to the directory assistance controller. A local or remote directory assistance database is queried from the directory assistance controller to identify the requested number and the requested number is forwarded to the directory assistance voice peripheral for delivery to the requesting subscriber. The call can then be routed to the end-office of the subscriber indicated by the requested number.

Service parameters for the subscriber requesting directory assistance may be determined by accessing the line information database (LIDB). Operator services automated message accounting records are generated at the SCP. Additionally, automated message accounting (AMA) records are generated at the end-office or tandem switch with SSP capabilities (or AIN SSP). The SCP sends an AMAsIpID parameter to the AIN SSP to record the DA service identification in the AIN SSP AMA record. In a wireless network, DMH_Billing_Digits are sent to the local switch in a wireless network to record the directory assistance (DA) service identification in the wireless switch billing record.

If the directory assistance voice peripheral fails to assist the subscriber the request for operator assistance can be sent from the requesting subscriber to an operator services switch (OSS) in communication with an operator. The directory assistance voice peripheral then plays any recorded subscriber segments for the operator without using dedicated voice links and passes received context information (e.g., city, state, and listing) to the OSS switch. The request is then released from the operator services switch and the call is forwarded to the end-office associated with the requested number.

In an alternate implementation automated directory assistance is invoked by the OSS.

### BRIEF DESCRIPTION OF THE DRAWINGS

FIG. 1 depicts network architecture for automated directory assistance in accordance with the present invention;

FIG. 2 depicts the call flow for the process of automated directory assistance for a wireline subscriber in accordance with the present invention when the call is invoked from the AIN SSP;

FIG. 3 depicts the call flow for the process of automated directory assistance for a wireless subscriber in accordance with the present invention when the call is invoked from the MSC;

FIGS. 4a and 4b depict the call flow for the process of adding operator intervention to the automated directory assistance method of the present invention for a wireline or wireless subscriber; and

FIGS. 5a and 5b depict the call flow for the process of automated directory assistance for a wireline or wireless subscriber in accordance with the present invention when the call is invoked from the Operator Services Switch (OSS).

### DETAILED DESCRIPTION

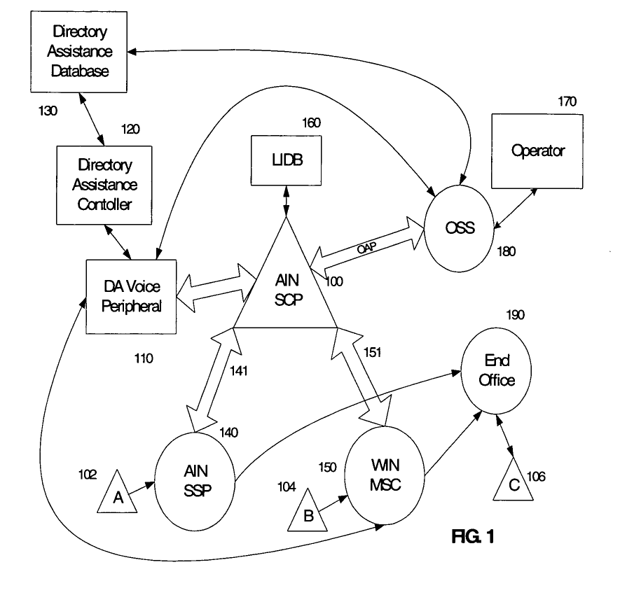

FIG. 1 depicts a system architecture in accordance with the present invention. Directory Assistance Voice Peripherals (DA_VP) 110 may be distributed or centralized in the network. The DA_VP 110 contains the intelligence to answer offered calls and, based on the routing number, present the caller with a scripted voice interface that prompts user input in the form of spoken voice or Dual Tone Multi-Frequency (DTMF) input. The DA_VP may be multi-functional and serve other voice interface purposes in addition to directory assistance. The DA_VP may incorporate VXML in addition to proprietary voice application scripting methodologies as needed by a specific system.

Directory Assistance Controller (DA_CTL) 120 appears singly but may be replicated in the network depending on the amount of traffic and availability requirements. The DA_CTL communicates with the DA_VPs via a data network and receives the results of caller responses to scripts in whole or in part, queries a local set of grammars to attempt to recognize the caller's utterance, either queries a local or centralized Directory Assistance Database (DADB) for the listing, and provides instructions back to the DA_VP. The DA_VP communicates with the Advanced Intelligent Network (AIN) Service Control Point (SCP) 100 via a data protocol to obtain instructions from the AIN SCP and to communicate to the SCP the results of the DA session.

Directory Assistance Database (DADB) 130 is a functional element that is comprised of one or more servers located at one or more locations that collectively provide directory listing information for the operating company and any client operators it may also serve.

Advanced Intelligent Network (AIN) Service Switching Point (SSP) 140 is the local end office (or tandem) switch configured to detect dialed digits that invoke DA, such as 411, suspend call processing and query an external SCP for further instructions.

Wireless Intelligent Network (WIN) Mobile Switching Center (MSC) 150 is the mobile switch configured to detect the dialed digits that invoke DA, such as 411, from mobile units, suspend call processing and query an external SCP for further instructions.

The Line Information Database (LIDB) 160 contains parameters that may be used to determine the type of service the line is subscribed to receive. It may contain information used by the SCP to play branding announcements, deny service, or determine language preference.

The AIN SCP 100 is the element that controls the call flows between all of the DA and switching systems. The SCP supports the AIN protocol for interfacing with the AIN SSP, the WIN protocol for interfacing with the WIN MSC, the Nortel Networks Open Automated Protocol (OAP) protocol to the Digital Multiplex Switch Traffic Operator Position System (DMS TOPS) and various other data protocols for interfacing with the DA_VP. The DMS TOPS switch is the operator services switch developed by Nortel Networks. OAP is a Nortel Networks-specified licensed protocol that is supported by the DMS TOPS switch.

Operator Services Switch (OSS) 180 is a switch designed specifically to handle live operator services such as the services of operator 170. Traffic Operator Position System (TOPS) is a Digital Multiplex Switch (DMS) from Nortel Networks with a software load design specifically for operator services and is the predominant operator services switch in the North American market. OSS 180 is also referred to herein as DMS TOPS switch or DMS TOPS.

End-office (EO) 190 is the end-office subtending the party whose number is returned by the system.

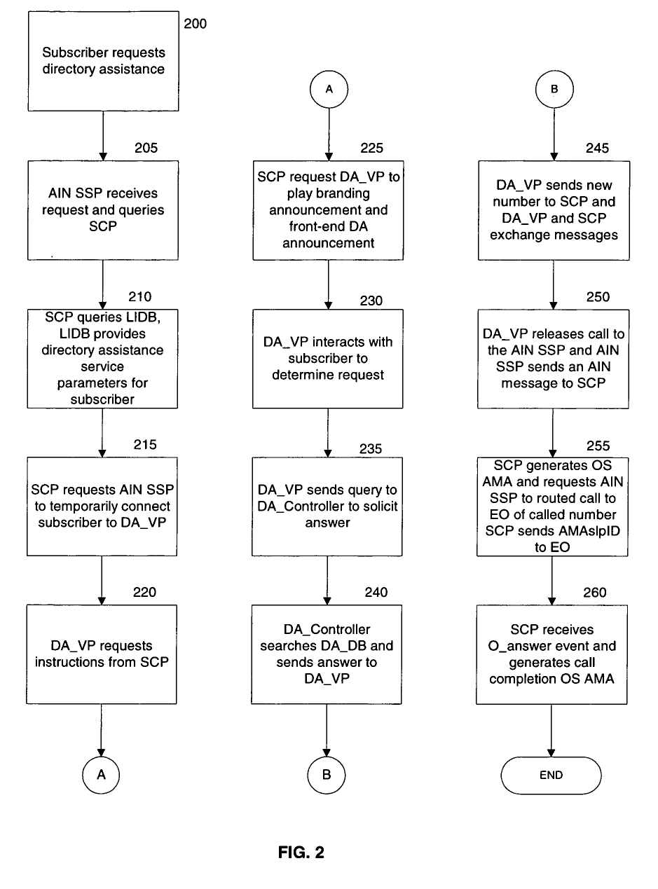

The system of FIG. 1 responds to directory assistance requests in the wireline environment in accordance with the following data flow as depicted in FIG. 2. At step 200, a subscriber, such as subscriber A 102 of FIG. 1 places a request for directory assistance, for example, by dialing the digits “411” on his or her wireline telephone. Upon arrival of the dialed digits 411 at the AIN SSP 140 that services subscriber A, the digits are analyzed at step 205 and the AIN SSP 140 queries the AIN SCP 100 for information regarding subscriber A. At step 210, the AIN SCP 100 sends a GetData query to the LIDB 160 to request Originating Line Number Screening (OLNS) information and the LIDB responds to the request by providing the OLNS information for subscriber A to the AIN SCP. At step 215, the AIN SCP 100 routes the directory assistance request (call) to the DA_VP 110 in communication with AIN SSP 140 by sending an AIN Send_To_Resource message to the AIN SSP. The DA_VP 110 answers the call at step 220. At step 225, The DA_VP 110 either obtains instructions from the AIN SCP via the call setup signaling or via a separate data interface using TCP/IP. The instructions request the DA_VP to play a specific branding announcement and to play the appropriate DA front-end script, such as a request for city and listing. At step 230, the DA_VP 110 interacts with the subscriber A 102 to determine the requested information (e.g., city and listing). DA_VP 110 then sends a query to the DA_Controller 120 to solicit the answer or instructions at step 235. At step 240, DA_Controller searches the DA_DB and determines the answer. Once the DA_Controller successfully finds the new called number, the DA_Controller 120 sends the new called number (i.e., the result of the request—in the example the telephone number for subscriber C 106) to DA_VP 110. At step 245, the DA_VP and AIN SCP exchange additional messages (e.g., the AIN SCP may request the DA_VP to play a specific back-end announcement). This exchange of messages may occur via the AIN SSP call setup signaling and AIN messages or via a separate data interface between the AIN SCP and DA_VP. At step 250, the DA_VP 110 releases the call to the AIN SSP 140 and the AIN SCP receives an AIN Resource_Clear from the AIN SSP. At step 255, AIN SCP 100 generates an operator services Automated Message Accounting (“AMA”) record for directory assistance (DA) and requests the AIN SSP to route the call with O_answer, O_no answer, and O-busy events and the call is routed from the AIN SSP 140 that first received the directory assistance request from caller A to the End Office 190 servicing subscriber C 106. At step 260, SCP 100 receives O_answer event and generates an operator services call completion AMA record excluding the conversation timing. After the call between subscriber A and subscriber C is cleared, the AIN SSP generates a call completion.

In contrast, in a prior art system a request for directory assistance would have been received from subscriber A 102 and the AIN SSP 140 would have forwarded the request to OSS 180. Further, in a prior art system, dedicated voice links are required between the OSS switch and the DA_VP and an active connection between the AIN SSP 140 and the OSS 180 would be required for the duration of the call.

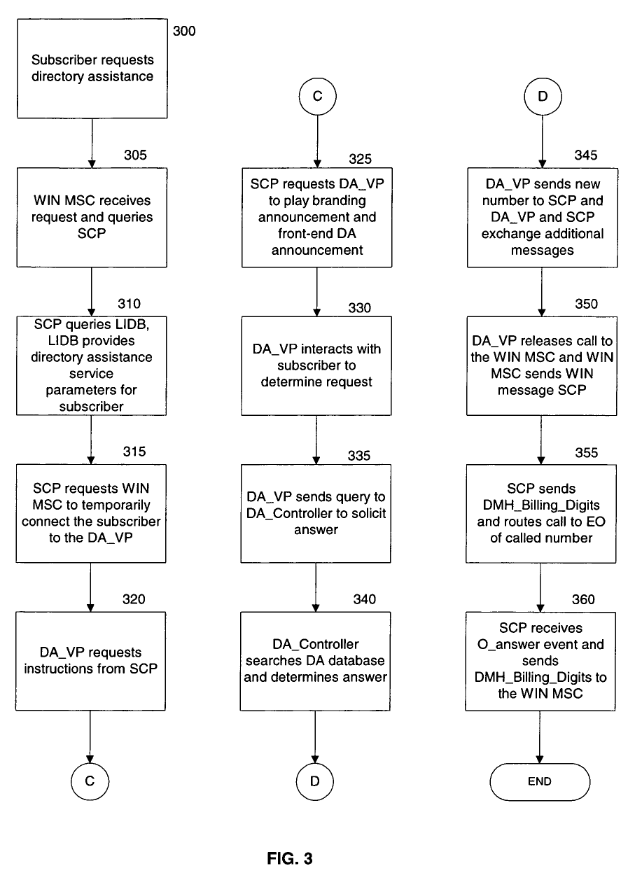

The system of FIG. 1 responds to directory assistance requests in the wireless environment in accordance with the following data flow as depicted in FIG. 3. At step 300, a subscriber such as subscriber B 104 places a request for directory assistance, for example, by dialing the digits “411” on his or her wireless telephone. Upon arrival of the dialed digits at the WIN MSC 150 that serves subscriber B, the digits are analyzed at step 305 and the WIN MSC 150 queries the AIN SCP 100 for call processing instructions. At step 310 the AIN SCP 100 sends a GetData query to the LIDB 160 requesting OLNS information and the LIDB responds to the request by providing the directory assistance service parameters for subscriber B to the WIN MSC. At step 315, the AIN SCP 100 requests the WIN MSC 150 to temporarily connect subscriber B to the DA_VP. At step 320, the DA_VP either obtains instructions from the AIN SCP via the SS7 signaling or via a separate data interface using TCP/IP. At step 325, the instructions request the DA_VP to play a specific branding announcement and to play the appropriate DA front-end script, such as a request for city and listing. At step 330, the DA_VP 110 interacts with subscriber B 104 to determine the requested information. At step 335, DA_VP 110 sends a query to the DA_Controller 120 to solicit the answer or instructions and DA_Controller 120 sends the new called number (i.e., the result of the request—in the example the telephone number for subscriber C 106) to DA_VP 110. At step 345, the DA_VP sends the new called number to the SCP and the DA_VP and AIN SCP exchange additional messages (e.g., the AIN SCP may request the DA_VP to play a specific back-end announcement. This exchange of messages may occur via the AIN SSP, call setup signaling and AIN messages or via a separate data interface between the AIN SCP and DA_VP. At step 350, The DA_VP 110 releases the call to the WIN MSC 150 and the SCP receives a WIN message from the WIN MSC informing the SCP of the disconnect. As part of this the SCP sends a CCDir message to the WIN MSC with TerminationList=CdPA and TriggerAddressList=Answer, No Answer, and Busy Event and the WIN MSC send a ccdir Return Result and odisconnect Return Result. At step 355, SCP 100 sends DMH_BillingDigits to enable billing by the wireless network operator and routes the call and requests O_answer, O_no answer, and O_busy events. The call is routed from the WIN MSC 150 that first received the directory assistance request from caller B to the End Office 190 serving subscriber C 106. At step 360, SCP 100 receives O_answer event and sends DMH_Billing Digits to the WIN MSC 150.

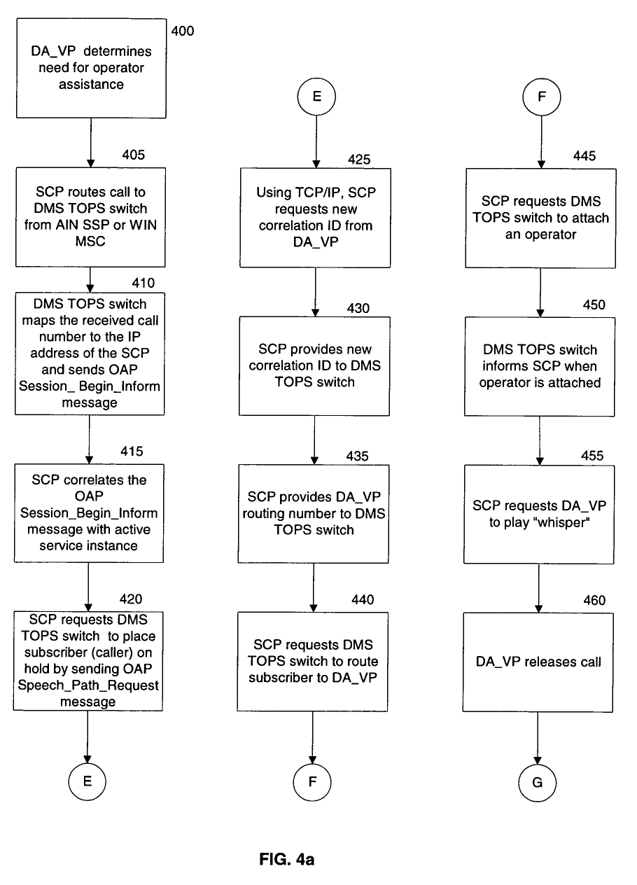

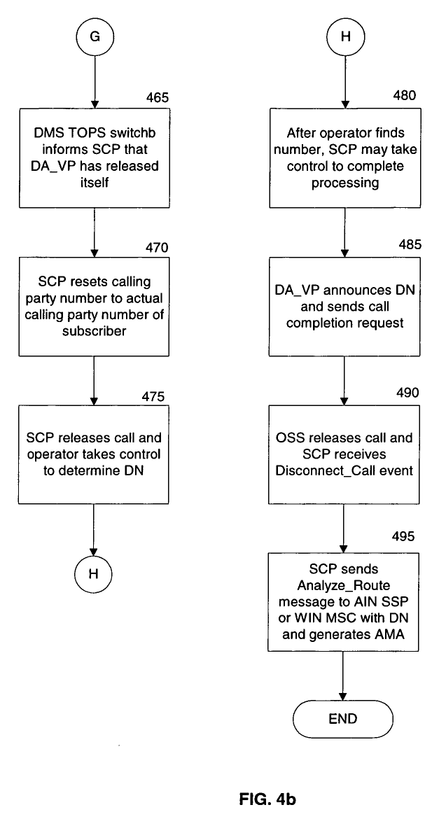

Including operator assistance in the method and system of the present invention can be accomplished in accordance with the call flow set forth in FIG. 4. Operator assistance may be necessary, for instance, in cases where the automated directory assistance described above fails to complete. At step 400 of FIG. 4 the subscriber or the DA_VP requests operator assistance causing the AIN SCP 100 to route the call to the OSS 180 at step 405. The AIN SCP requests the AIN SSP or WIN MSC to route the call to the OSS. The AIN SCP either requests the AIN SSP or WIN MSC to route the call over a specified trunk group or populates the called number with an NPA-NXX number identifying the OSS. When the OSS switch 180 is a DMS TOPS switch, AIN SCP populates the called number with a number that identifies the AIN SCP node and with a correlation ID used to map the OAP message received from the DMS TOPS switch to the context information associated with the existing service instance. At step 410, the DMS TOPS switch 180 maps the received call number to the IP address of the AIN SCP 100 and sends an OAP Session_Begin_Inform message including the correlation ID in the called number to the active SCP. At step 415, the SCP uses the correlation ID received in the Originally Dialed DN Data Block (DB) in the OAP Session_Begin_Inform message to correlate the received OAP message with the active service instance. At step 420, the AIN SCP requests the DMS TOPS switch to place the subscriber (caller) on hold by sending an OAP Speech_Path_Request message to the DMS TOPS switch requesting the OSS to set up a 0-way talking path between Subscriber A or B and the DMS TOPS switch 180. At step 425, using a TCP/IP interface, the AIN SCP requests the DA_VP for a correlation ID and routing number and provides this new correlation ID to the DMS TOPS switch intended for the DA_VP at step 430. The AIN SCP provides this correlation ID to the DMS TOPS switch by sending an OAP ISUP_Calling_Party_Number_Update_Request message to the DMS TOPS switch with the correlation ID populated in the ISUP Calling Party Number DB. At step 435, the AIN SCP then provides the DA_VP routing number to the DMS TOPS switch by sending a Directory_Number_Request message with the DA_VP routing number in the Directory Number DB. At step 440, the AIN SCP then requests the DMS TOPS switch 180 to connect subscriber A or subscriber B to the DA_VP by sending an OAP Connect_DN_Request message to the DMS TOPS switch. At step 445, the AIN SCP requests the DMS TOPS switch to attach an operator 170 by sending an OAP Passive_Function_Provider_Request message to the DMS TOPS switch. At step 450, the OSS switch informs the SCP when the operator is attached. The Passive_Function_Provider_Request message includes a Context Block DB with the recognized locality (e.g., city), area (e.g., state), address, and/or name. After the operator is attached, the SCP requests the DA_VP to play the “whisper” at step 455. After the DA_VP is finished playing the “whisper,” the DA_VP releases from the call at step 460, which may be based on instructions from the SCP. The DMS TOPS switch informs the SCP that the DA_VP released itself from the call at step 465. At step 470, the SCP resets the calling party number to the actual calling party number of subscriber A or B, if available, or to null, by sending a second OAP ISUP_Calling_Party_Number Update Request message. At step 475, The AIN SCP may then release itself from the call and the operator takes control of the call, which usually includes further interaction with the subscriber A or B.

Optionally, at step 480, the SCP may control the back-end service processing after the operator completes the assistance and finds the listing. At step 485, when the DA_VP announces the DN, it may determine that the call needs to be completed and request the DMS TOPS switch to release itself from the call by sending an OAP End Call Request message. At step 490, upon receipt of the OAP End Call Request message, the DMS TOPS Switch 180 releases the call and the AIN SCP 100 receives a O_Disconnect_Called event. At step 495, the AIN SCP sends an Analyze_Route message to the AIN_SSP 140 or a CCDir to the WIN MSC 150 that handled the call for the subscriber A 102 or subscriber B 104 with new DN and generates Automated Message Accounting (“AMA”) with the AMAsIpID contents or a billing record with DMH_Billing_Digits.

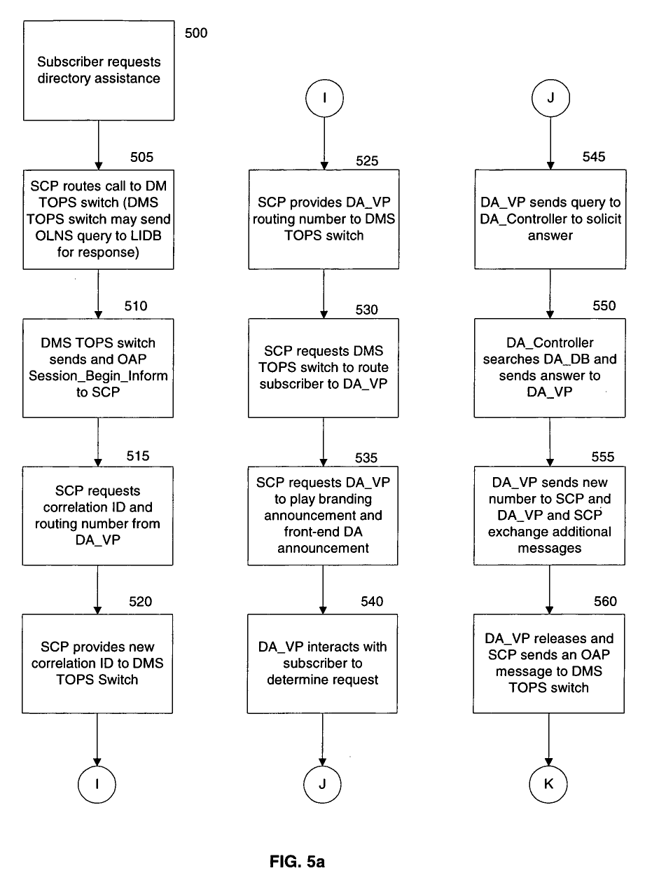

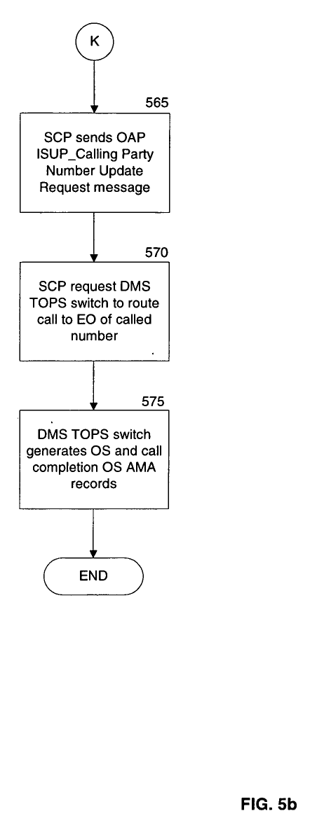

Invoking automated directory assistance from the DMS TOPS switch 180 in the method and system of the present invention can be accomplished in accordance with the call flow set forth in FIG. 5. At step 500, a subscriber, such as subscriber A 102 of FIG. 1 places a request for directory assistance, for example, by dialing the DA dialed digits, such as “411”, on his or her wireline telephone. Upon arrival of the dialed digits 411 at the EO 140 that serves subscriber A, the call is routed to the DMS TOPS switch at step 505. The DMS TOPS switch may send an OLNS query to LIDB and receive the response from LIDB. At step 510 the DMS TOPS switch sends an OAP Session_Begin_Inform message to the AIN SCP 100. At step 515, using a TCP/IP interface, the AIN SCP requests the DA_VP for a correlation ID and routing number and provides this new correlation ID to the DMS TOPS switch intended for the DA_VP, at step 520. The AIN SCP provides this correlation ID to the DMS TOPS switch by sending an OAP ISUP_Calling_Party_Number_Update_Request to the DMS TOPS switch with the correlation ID populated in the ISUP Calling Party Number DB. At step 525, the AIN SCP then provides the DA_VP routing number to the DMS TOPS switch by sending a Directory_Number_Request message with the DA_VP routing number in the Directory Number Update DB. At step 530, the AIN SCP then requests the DMS TOPS switch to connect subscriber A or subscriber B to the DA_VP by sending an OAP Connect_DN_Request message to the DMS TOPS switch. At step 535, the DA_VP obtains instructions from the SCP via a separate data interface using TCP/IP. The instructions request the DA_VP to play a specific branding announcement and to play the appropriate DA front-end script, such as a request for city and listing. At step 540, the DA_VP 110 interacts with the subscriber A 102 to determine the requested information (e.g., city and listing). DA_VP 110 then sends a query to the DA_Controller 120 to solicit the answer or instructions at step 545. At step 550, the DA_Controller searches the DA_DB and determines the answer. If the DA_Controller successfully finds the new called number, at step 550, the DA_Controller 120 sends the new called number (i.e., the result of the request—in the example the telephone number for subscriber C106) to DA_VP 110 at step 555 and the DA_VP and AIN SCP exchange additional messages (e.g., the AIN SCP may request the DA_VP to play a specific back-end announcement). This exchange of messages occurs via a data interface between the AIN SCP and DA_VP. At step 560, the DA_VP 110 releases the call to the DMS TOPS switch 180 and the DMS TOPS switch informs the AIN SCP of the release. At step 565, the SCP resets the calling party number to the actual calling party number of subscriber A, if available, or to null, by sending a second OAP ISUP_Calling_Party_Number Update Request message. At step 570, the AIN SCP sends the called number to the DMS TOPS switch by sending an OAP Directory_Number_Update request message with the called number in the Directory Number Update DB, changes the class charge and billing of the call, and releases itself from the call using an OAP Call_Float Request message. At step 575, the DMS TOPS switch completes the call to between subscriber A and the called party and generates an AMA record including conversation timing after the call is cleared. This unique aspect of this scenario compared to prior art is the implementation of the automated directory assistance using PSTN connections between the DMS TOPS switch and the DA_VP and without using dedicated voice links between the DMS TOPS switch and the DA_VP.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

I claim:

1. A method of providing automated directory assistance to one or more subscribers connected to a telecommunications network through a local or tandem switch with service switching point (SSP) capabilities each interacting with one or more directory assistance voice peripherals associated therewith comprising the steps of:
receiving a request for directory assistance from a first subscriber at a local or tandem switch;
routing said request to a service control point (SCP) in communication with said local or tandem switch;
temporarily connecting said request to an assigned directory assistance voice peripheral;
sending a message from the SCP to a directory assistance controller regarding directory assistance voice peripheral assigned said request;
soliciting through the assigned directory assistance voice peripheral information regarding said request from the requesting subscriber to form a directory assistance query;
forwarding the directory assistance query to the directory assistance controller;
querying a local or remote directory assistance database from the directory assistance controller to identify the requested number; and,
forwarding the requested number to the directory assistance voice peripheral for delivery to the requesting subscriber.

2. The method of claim 1 further comprising the step of determining the service parameters for the subscriber requesting directory assistance by accessing the line information database (LIDB).

3. The method of claim 1 further comprising the step of routing the call to the end-office of the subscriber indicated by the requested number.

4. The method of claim 1 further comprising the steps of:
releasing the request from the directory assistance voice peripheral to the SSP switch;
sending a call clearing indication from the SSP switch to the SCP;
routing the call from the SSP switch to the local end-office of the subscriber indicated by the requested number.

5. The method of claim 4 further comprising the step of generating operator services automated message accounting records at the SCP and sending an AMAsIpID parameter to the SSP switch.

6. The method of claim 4 further comprising the step of sending DMH_Billing_Digits to the local switch in a wireless network.

7. The method of claim 1 further comprising the steps of:
determining the need to provideoperator assistance to the requesting subscriber;
routing said request to an operator services switch (OSS) in communication with an operator;
playing from the selected directory assistance voice peripheral any recorded subscriber segments for the operator without using dedicated voice links;
and passing received context information to the OSS switch.

8. The method of claim 7 further comprising the steps of:
releasing the request from the operator services switch;
forwarding the call to the end-office associated with the requested number; and,
sending an analyze route request and automated message accounting to the AIN SSP for billing.

9. A directory assistance voice peripheral comprising:
a means for communicating with a service control point (SCP) for receipt of a directory assistance request from a subscriber;
a means for communicating with the subscriber to collect information about the directory assistance request to develop a directory assistance query;
a means for communicating with a directory assistance controller for forwarding the directory assistance query; and,
a means for receiving the answer to the directory assistance query from the directory assistance controller.

10. A method of providing automated directory assistance to one or more subscribers connected to a telecommunications network through an OSS switch with one or more directory assistance voice peripherals associated therewith comprising the steps of:
receiving a request for directory assistance from a first subscriber at a local switch;
routing said request to an OSS switch;
invoking directory assistance (DA) service at intelligent service control point (SCP) in communication with said OSS;
temporarily connecting said request to an assigned directory assistance voice peripheral via the PSTN without using dedicated voice links between the OSS and assigned directory assistance voice peripheral;
sending a message from the SCP to a directory assistance controller regarding directory assistance voice peripheral assigned said request;
soliciting through the assigned directory assistance voice peripheral information regarding said request from the requesting subscriber to form a directory assistance query;
forwarding the directory assistance query to the directory assistance controller;
querying the local or remote directory assistance database from the directory assistance controller to identify the requested number; and,
forwarding the requested number to the directory assistance voice peripheral for delivery to the requesting subscriber.
